(19) United States
(12) Patent Application Publication
(10) Pub. No.: US 2013/0334254 A1
(43) Pub. Date: Dec. 19, 2013

(54) Portable Fuel Container with Attachment Means

(71) Applicant: Steve Rose, Melbourne, FL (US)

(72) Inventor: Steve Rose, Melbourne, FL (US)

(21) Appl. No.: 13/906,534

(22) Filed: May 31, 2013

Related U.S. Application Data
(60) Provisional application No. 61/660,462, filed on Jun. 15, 2012.

(51) Int. Cl. B67D 7/84

(52) U.S. Cl. CPC B67D 3/0061
USPC 222/175

(57) ABSTRACT

Provided is a portable container for holding and dispensing a quantity of gasoline. The container includes an attachment for attaching the container to a support area, such as a belt loop, and a dispensing cap for dispensing the gasoline contained within the container. Additionally, the container is constructed of an approved material for storing gasoline, is painted bright red, and includes a warning that indicates the contents of the container. The internal volume of the container holds between 16-32 ounces of fuel, which provides extended use of conventional lawn equipment while being light enough to attach to a belt loop or other support area for hands-free use.

### CROSS REFERENCE TO RELATED APPLICATION

This application claims the benefit of U.S. Provisional Application No. 61/660,462, filed on Jun. 15, 2012, entitled “Quick Fill.” The above identified patent application is herein incorporated by reference in its entirety to provide continuity of disclosure.

### BACKGROUND OF THE INVENTION

1. Field of the Invention

The present invention relates to a fuel container. More specifically, it relates to a portable fuel container with an attachment means for securing the device to a belt loop or other personal support area for hauling a readily dispensable quantity of reserve fuel during lawn maintenance and construction activities.

A variety of lawn tools are known and available to assist individuals with maintaining their yard. In addition to conventional lawn tools such as hand rakes, shovels, and brooms, various types of powered lawn equipment are designed to increase the speed and efficiency of outdoor maintenance activities. Conventional powered lawn equipment such as lawnmowers, edgers, and trimmers help increase the speed and efficiency of yard maintenance. The majority of powered lawn equipment utilizes small, internal combustion engines that may be of two- or four-stroke design. As can be appreciated, an internal combustion engine is an power source whereby the combustion of a fuel occurs with air inside of a combustion chamber. Combustion of the fuel causes expansion of the ignited gases within the chamber, which applies force and work to an engine component such as a piston, turbine blade, or nozzle to drive the tool output.

The most common source of fuel for powered lawn equipment for internal combustion engines is gasoline, which is purchased at a gas station and stored in a fuel container. For many decades, fuel was commonly stored in a jerrycan, which is a container constructed from pressed steel. Modern fuel containers, however, are available in sizes ranging from one to five gallons or more and are often formed of a plastic material that contains the liquid fuel and vapors therein. Modern fuel containers are subject to both federal and state laws that require fuel containers to be painted bright red and plainly marked with the word “gasoline” or with the warning “flammable—keep fire away.” This ensures the contents of the container are easily identified for safety and kept away from heat sources or open flames.

Current fuel containers are designed to be filled at a gas station and transported to the power equipment for filling. This is preferable to transporting the power equipment to the gas station for filling, as many individuals do not have the capability to transport large equipment such as ride-on lawnmowers to the fuel source itself. Because of this, conventional fuel containers hold a large volume of gasoline to limit the number of trips to a gasoline filling station. While this is beneficial for preventing multiple trips to the gas station, it generally requires a user to transport the equipment in need of fuel to the fuel container or lug the large container to an area where it can be easily accessed. This may be impractical for users with large properties or for landscapers who care for multiple properties in the same neighborhood that are away from their fuel source.

When powered equipment runs out of gasoline and requires refueling, the homeowner and landscaper must stop working and return to the fuel source with the equipment in need of fuel. This extends the amount of time it takes for a homeowner to complete a project, or for a landscaper to finish maintaining a customer's property. To limit the number of trips back to the fuel source, a common practice involves storing gasoline in a conventional water bottle. As can be appreciated, conventional water bottles do not meet the legal requirements for storing fuel and may be mistaken for a water bottle holding a consumable beverage.

The present invention overcomes the problems inherent in conventional gasoline containers with a device that reduces the number of trips back to a fuel source for refilling garden power tools and equipment. The device comprises a portable container for holding a quantity of fuel for use in an internal combustion engine. The container meets current Environmental Protection Agency requirements for gas cans and is painted bright red in color with identifying indicia on the exterior of the container. The container additionally includes an attachment means for securing the container to a user's belt loop such that the user can walk with the quantity of fuel without being hampered or bothered during a work activity. The present invention provides a convenient way to carry a quantity of fuel that limits the number of trips back to a fuel source for refilling.

2. Description of the Prior Art

Devices have been disclosed in the prior art that relate to fuel containers. These include devices that have been patented and published in patent application publications, and generally relate to containers for holding a quantity of gasoline. The following is a list of devices deemed most relevant to the present disclosure, which are herein described for the purposes of highlighting and differentiating the unique aspects of the present invention, and further highlighting the drawbacks existing in the prior art.

Specifically, Durinzi, U.S. Pat. No. 5,226,574 discloses a portable gasoline container. The device is molded of plastic and includes a top fill opening, an upwardly-extending pouring spout, and handle regions molded into the container. The spout is slightly flexible and can be placed into the entrance end of a downwardly-extending inlet to an automobile gas tank. The container is then rotated about the axes of the spout so that the spout extends downwardly into the tank inlet and the body of the container is higher than the inlet. Once rotated, gasoline is dispensed through the spout into the gas tank. The Durinzi device is adapted for use with filling automobile gas tanks and does not disclose a container with an attachment means for securing to the belt loop of a user.

Hatch, U.S. Pat. No. 7,802,704 discloses a gasoline can having a nozzle assembly which includes a ball valve that is in an open mode when the can's nozzle is lifted for pouring and in a closed mode when the can's nozzle is in a lowered storage mode. The Hatch device describes a conventional fuel container with a novel nozzle assembly, but does not disclose an attachment means for securing the container to a user's belt.

Amrein, U.S. Pat. No. 4,982,881 discloses a nozzle for a fuel container that includes a first and second nozzle part. The first nozzle part comprises a flange for engaging a collar to secure it to a container, while a second nozzle part has an outlet opening that slidably engages the first nozzle part. A spring acts between the first and second nozzle parts to urge them apart. A valve member is secured to the second nozzle part and includes a closure member. This device discloses a nozzle for a conventional gas can, and does not disclose a portable fuel container.

Raboin, U.S. Pat. No. 6,435,380 discloses a spout for a container comprising a conduit having a first end connected to the container, an aperture, and a second end configured to be inserted into an opening. The second end of the conduit is configured to direct fluid out of the second end of the conduit. A closure plate extending across the diameter of the conduit prevents flow through the conduit. The closure plate has a closed position to inhibit flow through the conduit, and an open position to allow flow through the conduit. A sleeve movably responsive to inserting the conduit into the opening moves the closure plate from the closed position to the open position. Similar to the Amrein device, Raboin provides a spout with a spring-loaded closure means to prevent fuel vapors from escaping when the container is being stored.

Finally, Siciliano, U.S. Patent Application Publication No. 2011/0247994 discloses a securing member for a portable water bottle. The securing member comprises an elongated, flat member having a first end and a second end. The first end rotates about a first degree of freedom relative to the securing member so that the second end may move away from or towards the container surface. The first end also rotates about a second degree of freedom relative to the securing member so that the second end may move laterally relative to the container surface. While the Siciliano device provides a portable bottle with an attachment means, the bottle does not meet current Environmental Protection Agency requirements for gas cans, is not painted bright red in color, and does not include identifying indicia on the exterior of the container.

The devices disclosed in the prior art provide gas containers for holding a quantity of fuel for use with powered lawn equipment. These devices include a large internal volume to contain one or more gallons of fuel. As can be appreciated, a container of gasoline holding one or more gallons of fuel cannot be easily supported by a user on his or her waist. The present invention provides a fuel container designed to hold 16-32 ounces of fuel that includes an attachment means specifically designed to be supported on a user's belt loop. The size of the container and the attachment means allow a user to transport the present invention in a hands-free manner, thereby providing constant access to a source of fuel.

In light of the prior art and the disclosed elements of the present invention, it is submitted that the present invention substantially diverges in design elements from the prior art. Consequently, it is clear that the present invention is not described by the art and that a need exists for a fuel container with an attachment means that secures the device to a belt loop or support area. In this regard, the instant invention substantially fulfills these needs.

### SUMMARY OF THE INVENTION

In view of the foregoing disadvantages inherent in the known types of fuel containers now present in the prior art, the present invention provides a new fuel container wherein the same can be utilized for providing convenience for the user when filling an internal combustion engine with gasoline.

It is therefore an object of the present invention to provide a new and improved fuel container that has all of the advantages of the prior art and none of the disadvantages.

It is another object of the present invention to provide a fuel container for holding a small quantity of gasoline that is securable on the user's person during work activities.

Another object of the present invention is to provide a fuel container with an attachment means that secures the device to a belt loop or support area.

Yet another object of the present invention is to provide a fuel container that meets current EPA and OSHA regulations for gasoline containers.

Another object of the present invention is to provide a fuel container with a dispensing cap that fits into the opening of a powered lawn equipment fuel tank.

A final object of the present invention is to provide a fuel container that may be readily fabricated from materials that permit relative economy and that are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and the manner in which it may be made and used may be better understood after a review of the following description, taken in connection with the accompanying drawings wherein like numeral annotations are provided throughout.

FIG. 1 shows an exploded view of the present invention highlighting it constituent elements.

FIG. 2 shows a view of the present invention in a working position, wherein its attachment means is secured to a belt loop of a user's pants.

FIG. 3 shows a view of a conventional gas container dispensing fuel into the present invention.

### DETAILED DESCRIPTION OF THE INVENTION

Reference is made herein to the attached drawings. Like reference numerals are used throughout the drawings to depict like or similar elements of the container. For the purposes of presenting a brief and clear description of the present invention, the preferred embodiment will be discussed as used for storing and transporting a quantity of food for use in an internal combustion engine. The figures are intended for representative purposes only and should not be considered to be limiting in any respect.

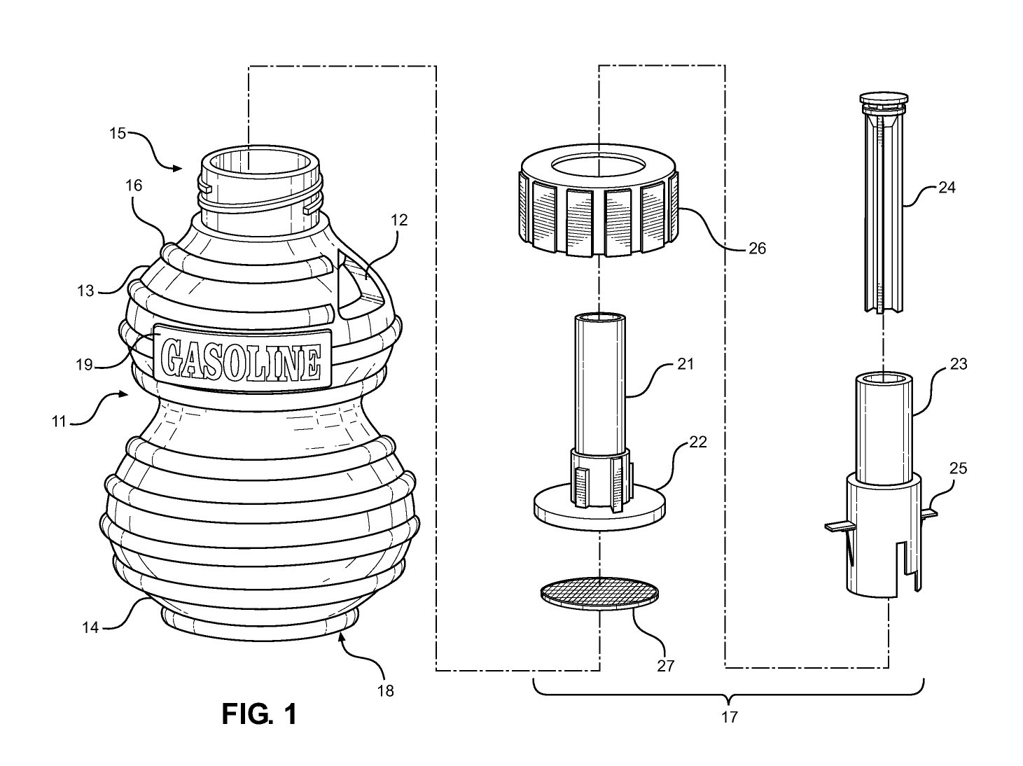

Referring now to FIG. 1, there is shown an exploded view of the present invention. The device comprises a portable container 11 for holding a quantity of fuel for an internal combustion engine. The container includes a generally cylindrical container body having an upper 13 end, a lower end 14, and sidewalls forming a partially enclosed interior volume for storing gasoline therein. An upper dispensing end 15 includes a shoulder 16 extending upwardly and inwardly towards a pour spout aperture that is adapted to be covered by a removable dispensing cap 17. The dispensing cap threadably and removably attached over the container aperture for controllably dispensing the contents from the container interior into the fuel tank of an article of lawn equipment. The lower end of the device comprises a container base 18 for supporting the container in an upstanding manner on a horizontal support surface, while a container aperture 12 is provided along the upper portion of the device for securing the container to a user's person. The attachment means can be integrated into the container, or can be integrated into the dispensing cap (not shown).

The container is designed for holding a small quantity of gasoline. In the preferred embodiment, the container has an internal volume for holding between 16 and 32 ounces of gasoline or a similar fluid. The container is constructed from an approved material for storing gasoline, such as polyethylene. Additionally, the container is painted in bright red, and includes indicia 19 printed on the exterior containing the word “gasoline” or with the warning “flammable—keep fire away.”

The container and dispensing cap meet both EPA and OSHA regulations for gas cans. In order to meet EPA regulations, the cap and container include a single, self venting opening for filling and pouring with no separate vents or openings. The body is treated for minimal permeation of fuels. The cap utilizes a spring loaded automatic closure system, wherein the device automatically springs to the closed position when not pouring. The cap utilizes an inner nozzle 21 with a base plate 22 that makes contact with the upper end of the container. An outer nozzle 23 attaches over the inner nozzle, while a flow stopper 24 creates a seal at the top of the cap. The cap threadably attaches to the container with a threaded cap retainer 26. The cap is sealed until the outer nozzle is pushed downward. A pair of tabs 25 extend from either side of the outer nozzle to facilitate opening.

In operation, a user inverts the bottle and inserts it into the fuel filling compartment of the device being filled with gasoline. The tabs make contact with the compartment and cause the outer nozzle to be depressed upon the inner nozzle. This causes the outer nozzle to slide downward, which opens the space between the outer nozzle and flow stopper. Gasoline can then flow through the inner nozzle and into the compartment. When complete, a user removes the device from the compartment, which causes the outer nozzle to close upon the flow stopper, thereby sealing the container. The nozzle additionally includes a child-resistant closure approved by the Children's Gasoline Burn Prevention Act. To meet OSHA regulations, the cap includes a flash arresting screen 27, and a spout cover designed to safely relieve internal pressure when subjected to fire exposure.

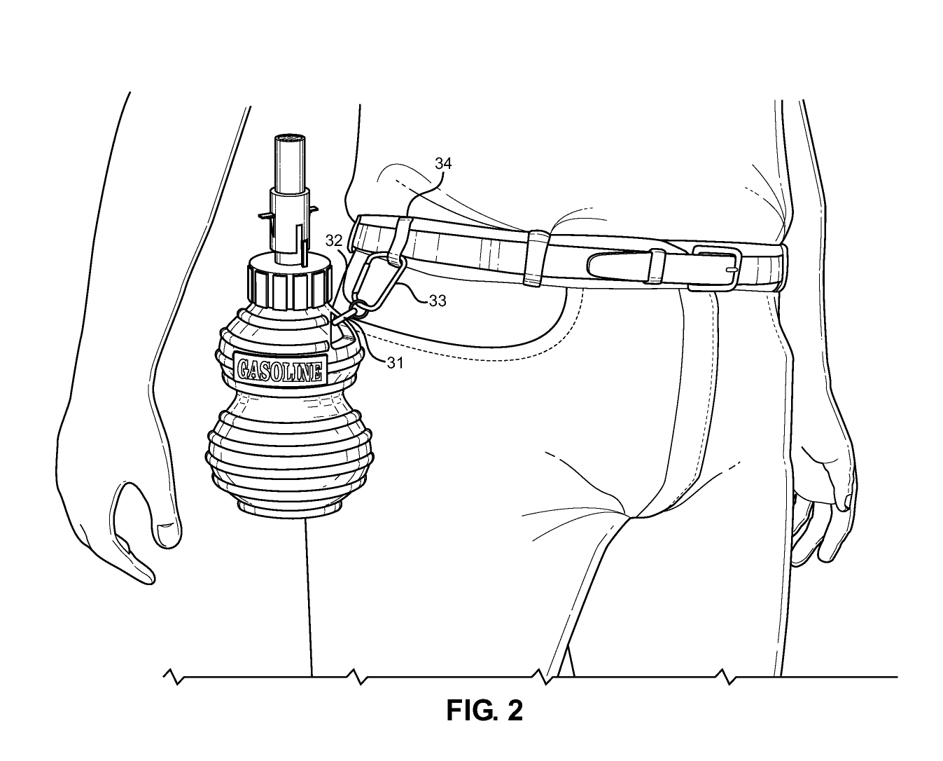

Referring now to FIG. 2, there is shown a view of the attachment means secured to a belt loop on a user. The attachment means enables the container 11 to be secured to a desired location. In the preferred embodiment, the attachment means includes an aperture 12 formed within the container, a first and second annular ring 31, 32, and a clip 33. The first annular ring is secured to the container and the second annular ring is secured around the first ring. The clip is then secured to the second ring, thereby enabling the entire system to be repositioned when attached to a user. The clip may comprise a conventional carabineer, spring loaded clip, or a similar device that can be quickly attached and detached from a support area. As shown, the attachment means enables attachment of the container to a belt loop 34. Attachment to a belt loop or similar support area enables hands free transport of the container. A user is free to operate the power equipment or perform other tasks with both hands. When access to the fuel container is desired, the clip can be detached from the belt loop or support area, and the fuel within the container can be dispensed as needed. Once dispensing is complete, the container can be reattached to the belt loop.

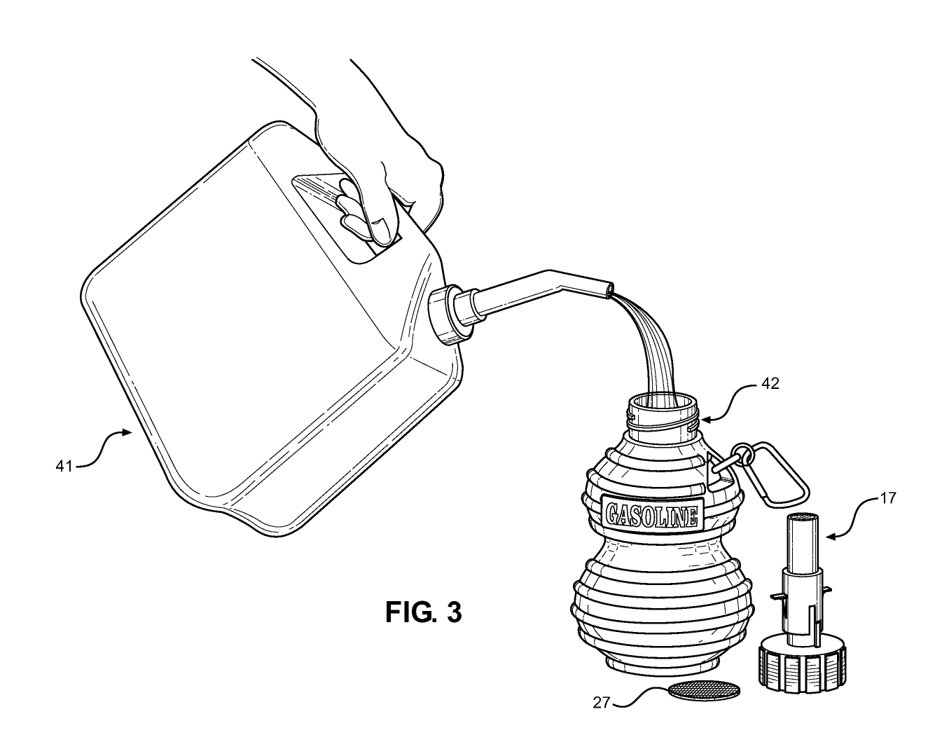

Referring now to FIG. 3, there is shown a view of a conventional gas can dispensing fuel into the present invention. The container 11 of the present invention is designed to hold a small quantity of fuel for use with an internal combustion engine. The dispensing cap 17 is removed from the container, and a conventional gas can 41 is used to transfer fuel into the container. The container includes threads 42 for attaching and detaching the dispensing cap. Once fuel is transferred into the container, the dispensing cap is threadably attached, and the device can be transported by a user. The container can be carried or attached via the clip 33 to a support area, such as a belt loop. When the lawn equipment requires refueling, the attachment means is released from the support area, and the dispensing cap is placed within the fuel tank opening. The cap makes contact with the fuel compartment and opens for dispensing. Once refueling is complete, the container is removed from the compartment and reattached to the support area until the user returns to the fuel source, at which time the container can be refilled with gas.

Overall, the present invention provides a user with a convenient means of refueling powered lawn equipment. The device can transport a quantity of fuel for work in areas away from the main fuel source. The quantity of fuel in the container provides extended use of conventional lawn equipment, while being light enough to attach to a belt loop or other support area for hands-free use. The red color of the container and warning indicia identify the contents of the container to prevent accidental ingestion. Additionally, construction of the container and the dispensing cap enable use of the device on job sites that are regulated by OSHA.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A personal, portable container for dispensing gasoline, comprising:
a container body having an upper dispensing end, a lower end, sidewalls, and an interior volume;
said lower end comprising a container base for supporting said container in an upstanding manner on a horizontal support surface;
said upper dispensing end comprising a container aperture for communicating fluid from said container interior volume;
an attachment means along said upper dispensing end for attaching said container to a support area;
a dispensing cap that removably attaches to said upper dispensing end over said aperture for controllably dispensing a quantity of gasoline therethrough.

2) The device of claim 1, wherein said quantity of gasoline is between 16 and 32 ounces.

3) The device of claim 1, wherein said container is constructed from an approved material for storing gasoline.

4) The device of claim 3, wherein said approved material is polyethylene.

5) The device of claim 1, wherein said container is painted bright red and includes warning indicia on the exterior thereof.

6) The device of claim 1 wherein said dispensing cap and container include a single, self-venting opening for filling and pouring with no separate vents or openings.

7) The device of claim 1, wherein said container is treated for minimal permeation of fuels.

8) The device of claim 1, wherein said dispensing cap utilizes an inner nozzle having a base plate that makes contact with said container body upper end, an outer nozzle that attaches over said inner nozzle, a flow stopper, a threaded cap retainer, and a pair of tabs extending from either side of said outer nozzle.

9) The device of claim 1, wherein said nozzle includes a child-resistant closure.

10) The device of claim 1, wherein said attachment means includes an aperture formed within said container, a first and second annular ring, and a clip.

11) The device of claim 1, wherein said attachment means includes an annular tab, an annular ring, and a clip.

12) The device of claim 11 wherein said annular tab is integrated into said dispensing cap.

13) The device of claim 11 wherein said annular tab is integrated into said container.

14) The device of claim 11, wherein said clip is a carabineer.

15) The device of claim 1, wherein said container includes threads for attaching and detaching said dispensing cap.
